(19) United States
(12) Patent Application Publication
(10) Pub. No.: US 2026/0294117 A1
(43) Pub. Date: Oct. 1, 2026

(54) FURNITURE PIECE WITH VIDEO PROJECTOR

(71) Applicant: MOTOMOTION CHINA CORPORATION, CHANGZHOU (CN)

(72) Inventors: WU QING PAN, CHANGZHOU (CN); RONG CAI, CHANGZHOU (CN)

(21) Appl. No.: 19/089,432

(22) Filed: Mar. 25, 2025

(51) Int. Cl. A47C 7/72; A47C 17/86; G03B 29/00

(52) U.S. Cl. CPC A47C 7/72; A47C 17/86; G03B 29/00

(57) ABSTRACT

A furniture piece with a video projector comprises a base, a backrest connected to the base, a cavity defined within the backrest, a cover pivotally mounted upon the backrest so as to be movable between a closed position and an open position, and a video projector mounted upon an interior surface of the cover such that when the cover is disposed at the closed position, the video projector will be disposed within the cavity and hidden from view, whereas when the cover is disposed at the open position, the video projector will be disposed externally of the cavity so as to be capable of projecting a video image for viewing. Alternatively, the video projector can be mounted upon a movable headrest of the furniture piece.

### FIELD OF THE INVENTION

The present invention relates generally to furniture pieces, and more particularly to a furniture console having a video projector incorporated therein so that people sitting upon adjacent sofas, chairs, furniture sectionals, and the like, can enjoy video programming without the need for a TV.

### BACKGROUND OF THE INVENTION

Powered furniture pieces have become very popular wherein the furniture pieces are comprised of various structural components whereby the furniture piece can attain any one of several various positions, such as, for example, a sitting position, a TV position, a reclined position, a lift position, a zero-gravity position, and the like. In addition, some furniture pieces are also equipped with additional electronic components, such as, for example, an integrated audio system so as to enable users to listen to music or to enjoy a more vibrant and dynamic sound when watching movies or other videos. One example of such a system is disclosed within Chinese Utility Model CN 222340895U wherein the system, as disclosed within FIG. 1, is generally indicated by the reference character 100 and is seen to comprise a furniture system or arrangement comprising a plurality of furniture sectionals. More particularly, it is seen that the furniture system 100 comprises at least one corner chair 102, at least one central chair 104, a corner sectional 106, at least one love seat 108, and at least one corner sofa 110. In addition, a console 112 is interposed between the corner chair 102 and the central chair 104. Still further, it is seen that a plurality of audio components 114 are incorporated within strategically placed corner regions of the sofa system 100 so as to effectively create an audio system that can generate “surround sound” audio which will enhance the sound effects of the audio system when a user is listening to music or watching a movie. Continuing further, however, in order for a user of the furniture system 100 to use the system 100 to its full potential, a TV or projector is necessary. This effectively presents a spatial or logistics problem in that the storage or accommodation of the TV or projector requires additional space. In addition, the TV or projector needs to be electronically connected to the audio components 114 by means of suitable audio and video transmission cables, however, the presence of such external audio and video transmission cables, and their connections to the audio components 114, present a safety hazard.

A need therefore exists in the art for a new and improved furniture console. Another need exists in the art for a new and improved furniture console which can be incorporated within a furniture system. Still another need exists in the art for a new and improved furniture console which can be incorporated within a furniture system which comprises a plurality of furniture sectionals. Yet another need exists in the art for a new and improved furniture console which can be incorporated within a furniture system which comprises a plurality of furniture sectionals, and wherein the furniture console is one of the plurality of furniture sectionals. Still yet another need exists in the art for a new and improved furniture console which can be incorporated within a furniture system which comprises a plurality of furniture sectionals, wherein the furniture console is one of the plurality of furniture sectionals, and wherein the furniture console has a video projector incorporated therein. Yet still another need exists in the art for a new and improved furniture console which can be incorporated within a furniture system which comprises a plurality of furniture sectionals, wherein the furniture console is one of the plurality of furniture sectionals, wherein the furniture console has a video projector incorporated therein, and wherein the video projector can be integrated with an audio system which is also incorporated within the furniture system. A further need exists in the art for a new and improved furniture console which can be incorporated within a furniture system which comprises a plurality of furniture sectionals, wherein the furniture console is one of the plurality of furniture sectionals, wherein the furniture console has a video projector incorporated therein, and wherein the video projector can be integrated with an audio system, which is also incorporated within the furniture system, such that users can listen to music or enjoy a more vibrant and dynamic sound when watching movies or other videos. A yet further need exists in the art for a new and improved furniture console which can be incorporated within a furniture system which comprises a plurality of furniture sectionals, wherein the furniture console is one of the plurality of furniture sectionals, wherein the furniture console has a video projector incorporated therein, and wherein the video projector can be integrated with an audio system, which is also incorporated within the furniture system, such that users can listen to music or enjoy a more vibrant and dynamic sound when watching movies or other videos, without the need for an external TV or projector with their additional, external audio and video transmission cables and the need to connect the same to the audio system of the overall furniture system.

### OVERALL OBJECTIVES OF THE INVENTION

Accordingly, a first overall objective of the present invention is to provide a new and improved furniture console. Another overall objective of the present invention is to provide a new and improved furniture console which can be incorporated within a furniture system. Still another overall objective of the present invention is to provide a new and improved furniture console which can be incorporated within a furniture system which comprises a plurality of furniture sectionals. Yet another overall objective of the present invention is to provide a new and improved furniture console which can be incorporated within a furniture system which comprises a plurality of furniture sectionals, and wherein the furniture console is one of the plurality of furniture sectionals. Still yet another overall objective of the present invention is to provide a new and improved furniture console which can be incorporated within a furniture system which comprises a plurality of furniture sectionals, wherein the furniture console is one of the plurality of furniture sectionals, and wherein the furniture console has a video projector incorporated therein. Yet still another overall objective of the present invention is to provide a new and improved furniture console which can be incorporated within a furniture system which comprises a plurality of furniture sectionals, wherein the furniture console is one of the plurality of furniture sectionals, wherein the furniture console has a video projector incorporated therein, and wherein the video projector can be integrated with an audio system which is also incorporated within the furniture system. A further overall objective of the present invention is to provide a new and improved furniture console which can be incorporated within a furniture system which comprises a plurality of furniture sectionals, wherein the furniture console is one of the plurality of furniture sectionals, wherein the furniture console has a video projector incorporated therein, and wherein the video projector can be integrated with an audio system, which is also incorporated within the furniture system, such that users can listen to music or enjoy a more vibrant and dynamic sound when watching movies or other videos. A yet further overall objective of the present invention is to provide a new and improved furniture console which can be incorporated within a furniture system which comprises a plurality of furniture sectionals, wherein the furniture console is one of the plurality of furniture sectionals, wherein the furniture console has a video projector incorporated therein, and wherein the video projector can be integrated with an audio system, which is also incorporated within the furniture system, such that users can listen to music or enjoy a more vibrant and dynamic sound when watching movies or other videos, without the need for an external TV or projector with their additional, external audio and video transmission cables and the need to connect the same to the audio system of the overall furniture system.

### SUMMARY OF THE INVENTION

The foregoing and other objectives of the present invention are achieved through the provision of a furniture console wherein the same comprises a base, and an upstanding backrest fixedly connected to the rear end portion of the base. A hollow cavity is defined within the backrest, and a cover is pivotally mounted upon an upper end portion of the backrest. A projector is fixedly mounted upon an interior portion of the cover, and a power assembly is operatively connected to the cover so as to move the same between a closed position and an open position. When the cover is moved to its open position, the projector will be disposed within a horizontal orientation so as to be readily capable of projecting video images onto a screen or wall disposed opposite the console once an ON switch, on the projector, is depressed or otherwise activated. Alternatively, the video projector may be mounted upon a headrest of a furniture piece.

### BRIEF DESCRIPTIONS OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a perspective view of a conventional PRIOR ART furniture system or arrangement which comprises a plurality of furniture sectionals having an audio system integrated therein;

FIG. 2 is a front, right side perspective view of a first embodiment of a new and improved furniture console having a video projector mounted therein, and wherein the front cover of the furniture console backrest is disposed at its open position;

FIG. 3 is a side elevational view of the new and improved furniture console as shown in FIG. 2;

FIG. 4 is a side elevational view of the new and improved furniture console as shown in FIGS. 2 and 3, however, the front cover of the furniture console backrest is disposed at its closed position;

FIG. 5 is a front, left side perspective view of a second embodiment of a new and improved furniture piece having a video projector mounted upon a movable headrest of the furniture piece, and wherein the headrest of the furniture piece is disposed at its retracted position;

FIG. 6 is a front, left side perspective view of the second embodiment of the new and improved furniture piece, as illustrated within FIG. 5, wherein the headrest of the furniture piece is disposed at its extended position; and

FIG. 7 is a rear, left side perspective view of the second embodiment of the new and improved furniture piece, as disclosed within FIGS. 5 and 6, wherein the headrest of the furniture piece is disposed at its extended position and the various power cables are routed through the back of the furniture piece.

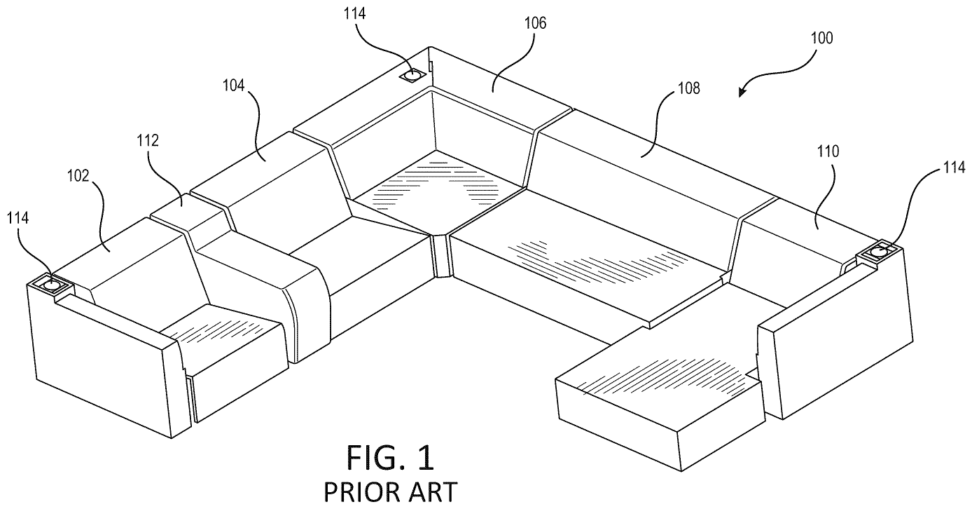

### DETAILED DESCRIPTION OF THE ILLUSTRATED EMBODIMENTS

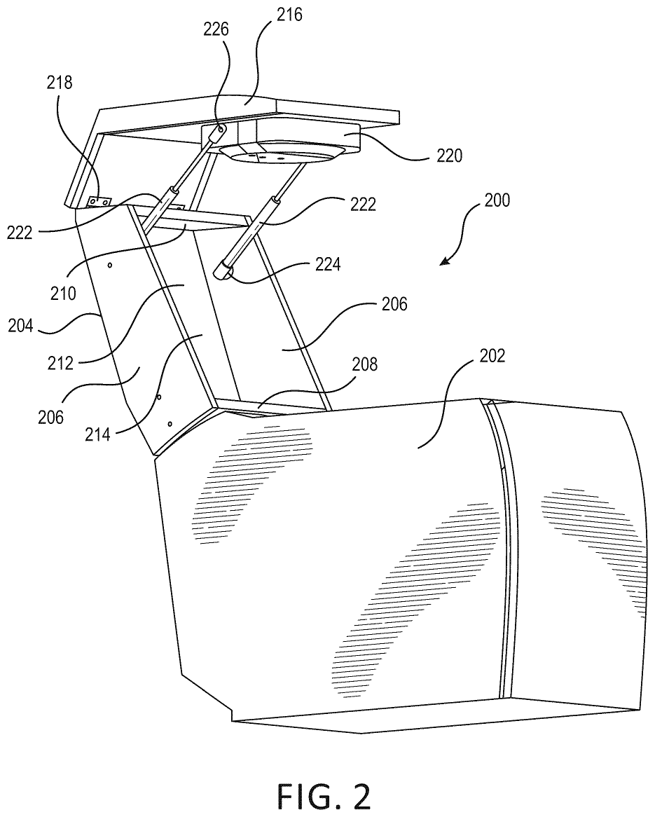

Referring now to the drawings, and more particularly to FIGS. 2-4 thereof, there is disclosed a new and improved furniture console which has been developed in accordance with the principles and teachings of the present invention and which is generally indicated by the reference character 200. More particularly, it is seen that the new and improved furniture console 200 comprises a base 202, and an upstanding backrest 204 fixedly connected to the rear end portion of the base 202. The backrest 204 comprises a pair of oppositely disposed side walls 206,206, a bottom wall 208, a top wall 210, and a back wall 212, wherein, as can readily be appreciated, the pair of oppositely disposed side walls 206,206, the bottom wall 208, the top wall 210, and the back wall 212 collectively define a hollow interior cavity 214. In addition, a front cover 216 is pivotally mounted upon an upper end portion of the backrest 204 by means of a pair of laterally spaced hinge mechanisms 218, and a video projector 220 is fixedly mounted upon an interior wall portion of the front cover 216. In conjunction with the mounting of the video projector 220 upon the interior wall portion of the front cover 216, a power assembly is operatively connected to the front cover 216 so as to move the same between a closed position and an open position. More particularly, it is seen that the power assembly comprises a pair of laterally spaced hydraulic piston-cylinder assemblies 222, wherein lower end portions of the hydraulic piston-cylinder assemblies 222 are pivotally mounted upon the pair of oppositely disposed side walls 206, 206, as at 224, while upper end portions of the hydraulic piston-cylinder assemblies 222 are pivotally mounted upon interior surface portions of the front cover 216 which are located upon opposite sides of the video projector 220 as at 226.

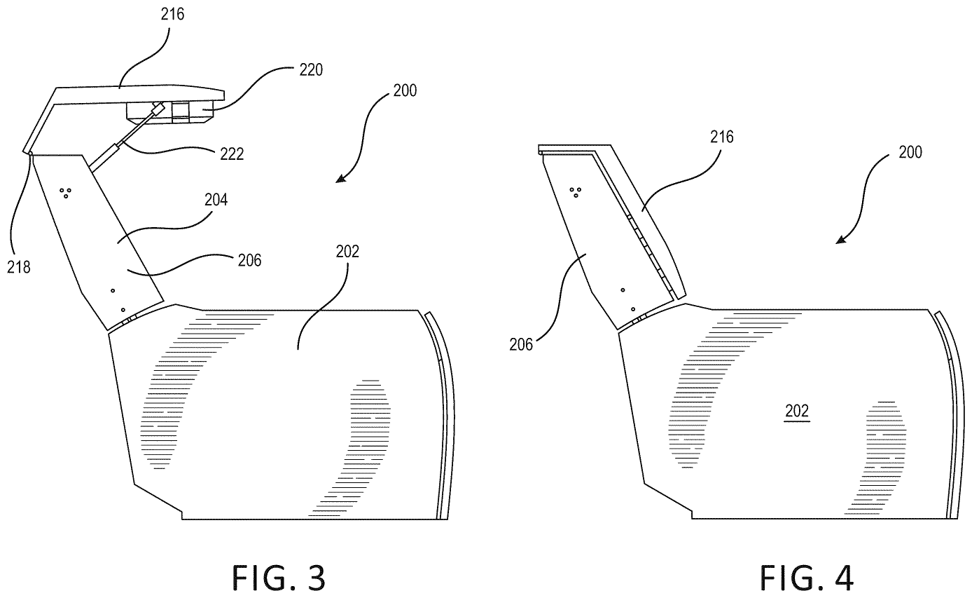

By providing the pair of laterally spaced hydraulic piston-cylinder assemblies 222, the front cover 216 of the console 200 will be able to be moved between its open and closed positions in a stable manner as a result of manually moving the same from the closed position shown in FIG. 4 to its open position shown in FIGS. 2 and 3. More particularly, as is well known, as the rod portions of the hydraulic piston-cylinder assemblies 222 are extended and retracted, hydraulic fluid will be moved internally within the cylinder such that the hydraulic fluid will maintain the rod at its extreme position corresponding to when the front cover 216 is disposed at its open or closed position. In addition, as can be readily appreciated from FIGS. 2 and 3, it is also noted that when the front cover 216 is moved to its open position, the video projector 220 will be disposed within a horizontal orientation so as to be readily capable of projecting video images onto a screen or wall disposed opposite the furniture console 200 once an ON switch, on the video projector 220, or upon a suitable remote control, not shown, is depressed or otherwise activated. To the contrary, when the front cover 216 is moved to its closed position, the cavity 214 will be hidden, as will the video projector 220, and the backrest 204 is effectively continuous with the base 202 so as to present an aesthetically clean, smooth, and pleasing appearance. In addition, it is noted that in lieu of the pair of laterally spaced hydraulic cylinders 222, a linear actuator may be utilized.

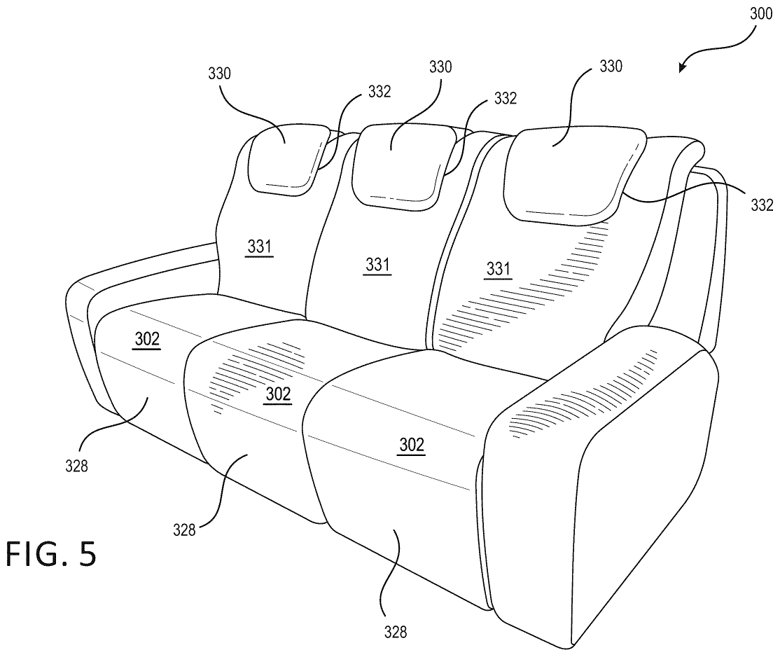

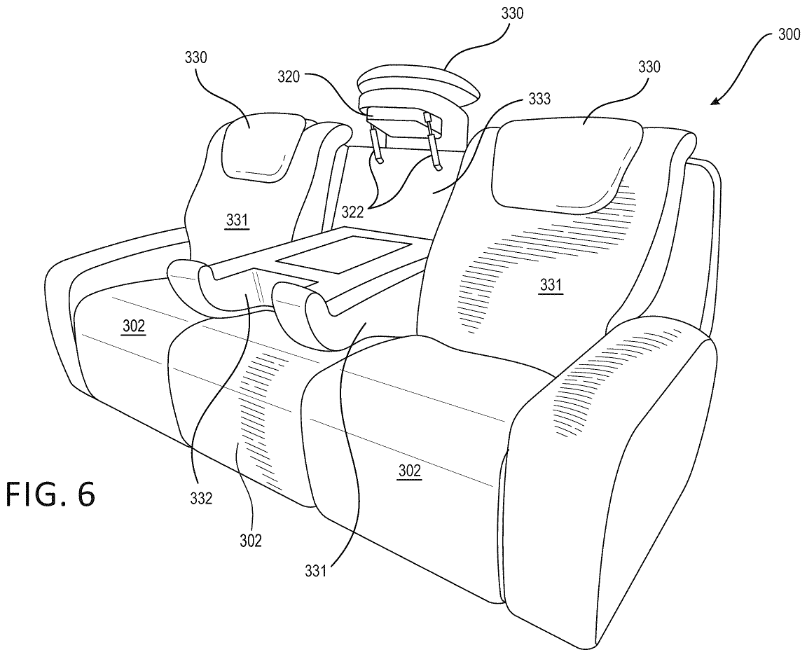

Lastly, with reference now being made to FIGS. 5-7, a second embodiment furniture piece of the present invention is disclosed and is generally indicated by the reference character 300. It is to be noted that, except as otherwise noted, the second embodiment furniture piece 300 is essentially the same as the first embodiment furniture piece 200, and therefore, component parts of the second embodiment furniture piece 300, that correspond to component parts of the first embodiment furniture piece 200, will be designated by corresponding reference characters but they will be within the 300 series.

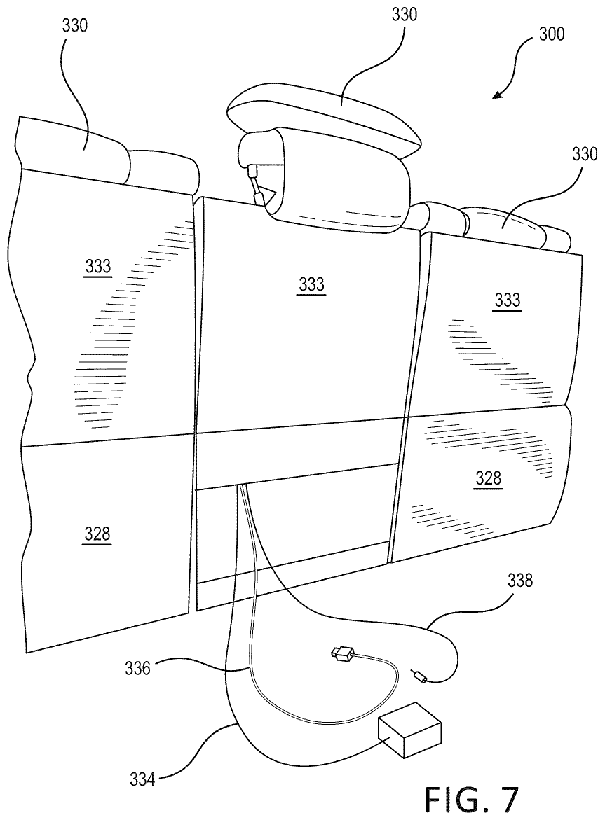

More particularly, as can best be seen and appreciated from FIGS. 5-7, it is seen that the furniture piece 300 comprises a couch, sofa, a chair, a love seat, or the like, and that each section 328 of the furniture piece 300 has a movable headrest 330 operatively associated therewith, wherein the movable headrest 330 is movable between a retracted position, as illustrated within FIG. 5, and an extended position as illustrated within FIGS. 6 and 7. As can also be best appreciated from FIGS. 5 and 6, each one of the backrest sections of the furniture piece 300 comprises a forward backrest section 331 which is movable between an upright position when the associated headrest 330 is disposed at its retracted position, and a downward position when the associated headrest 330 is disposed at its extended position. In order to permit each one of the forward backrest sections 331 to structurally interact with each one of the headrests 330, it is seen that each one of the forward backrest sections 331 has a substantially U-shaped configuration wherein the upper portion of each forward backrest section 331 effectively defines a cut-out section 332 which can spatially accommodate its associated headrest 330 when the headrest 330 is moved to its retracted position. In addition, and at the same time that the headrest 330 is moved to its extended position, the forward backrest section 331 will be disposed at its downward position so as to effectively serve as a console or a horizontally oriented platform. As can be appreciated still further, a video projector 320 is fixedly mounted upon an interior or undersurface portion of the headrest 330 and is supported by means of a pair of laterally spaced hydraulic cylinders 322 which are mounted upon rearward sections 333 of each backrest. Lastly, it is noted that the various cables for the furniture piece 200,300 and the video projector 220,320, such as, for example, a power cable 334 for providing electrical to the various movable structural components of the furniture piece, as well as for providing electrical power to the video projector 220,320, an AUX cable 336, as well as an audio cable 338, which are to be operatively connected to an audio amplifier, not shown, that is incorporated internally within the furniture piece 200,300, may be routed in an unobtrusive manner through a rear portion of the furniture piece 200,300 as is shown in FIG. 7.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent, is:

1. A furniture piece having a video projector operatively associated therewith, comprising:
a base;
a backrest fixedly connected to a rear end portion of said base;
a cavity defined within said backrest;
a cover pivotally mounted upon said backrest so as to be movable between a closed position, at which said cover covers said cavity, and an open position wherein said cover uncovers said cavity; and
a video projector mounted upon an interior surface of said cover such that when said cover is disposed at said closed position, said video projector will be disposed within said cavity and hidden from view, whereas when said cover is disposed at said open position, said video projector will be disposed externally of said cavity so as to be capable of projecting a video image for viewing.

2. The furniture piece as set forth in claim 1, wherein:
said furniture piece comprises a console.

3. The furniture piece as set forth in claim 1, wherein:
said cavity is defined by a back wall of said backrest, a top wall, a bottom wall, and a pair of oppositely disposed side walls.

4. The furniture piece as set forth in claim 3, further comprising:
at least one actuator operatively connected between said backrest and said cover for moving said cover between said open and closed positions.

5. The furniture piece as set forth in claim 4, wherein:
a first end of said at least one actuator is pivotally mounted upon at least one of said pair of oppositely disposed side walls, while a second end of said at least one actuator is pivotally mounted upon an interior surface portion of said cover.

6. The furniture piece as set forth in claim 5, wherein:
said at least one actuator comprises a hydraulic piston-cylinder assembly.

7. The furniture piece as set forth in claim 4, wherein:
said at least one actuator comprises a pair of oppositely disposed actuators.

8. The furniture piece as set forth in claim 7, wherein:
first ends of said pair of oppositely disposed actuators are pivotally mounted upon said pair of oppositely disposed side walls, while second ends of said pair of oppositely disposed actuators are pivotally mounted upon interior surface portions of said cover.

9. The furniture piece as set forth in claim 8, wherein:
said second ends of said pair of oppositely disposed actuators are pivotally mounted upon interior surface portions of said cover which are disposed upon opposite sides of said video projector mounted upon said interior surface portion of said cover.

10. The furniture piece as set forth in claim 7, wherein:
said pair of oppositely disposed actuators comprise a hydraulic piston-cylinder assemblies.

11. A furniture piece having a video projector operatively associated therewith, comprising:
a base;
a backrest operatively connected to a rear end portion of said base;
a headrest movably mounted upon said backrest between a retracted position and an extended position; and
a video projector mounted upon an undersurface portion of said headrest such that when said headrest is disposed at said retracted position, said video projector will be hidden from view, whereas when said headrest is disposed at said extended position, said video projector will be disposed at a position so as to be capable of projecting a video image for viewing.

12. The furniture piece as set forth in claim 11, wherein:
said furniture piece is selected from the group comprising a sofa, a couch, a chair, and a love seat.

13. The furniture piece as set forth in claim 1, wherein:
said backrest is disposed at an upright position when said headrest is disposed at said retracted position, whereas when said headrest is disposed at said extended position, said backrest is disposed at a downward position.

14. The furniture piece as set forth in claim 13, further comprising:
at least one actuator operatively connected between said backrest and said headrest for moving said headrest between said extended and retracted positions.

15. The furniture piece as set forth in claim 14, wherein:
a first end of said at least one actuator is pivotally mounted upon a rearward section of said backrest, while a second end of said at least one actuator is pivotally mounted upon an interior surface portion of said headrest.

16. The furniture piece as set forth in claim 15, wherein:
said at least one actuator comprises a hydraulic piston-cylinder assembly.

17. The furniture piece as set forth in claim 14, wherein:
said at least one actuator comprises a pair of oppositely disposed actuators.

18. The furniture piece as set forth in claim 17, wherein:
first ends of said pair of oppositely disposed actuators are pivotally mounted upon a rearward section of said backrest, while second ends of said pair of oppositely disposed actuators are pivotally mounted upon interior surface portions of said headrest.

19. The furniture piece as set forth in claim 18, wherein:
said second ends of said pair of oppositely disposed actuators are pivotally mounted upon interior surface portions of said headrest which are disposed upon opposite sides of said video projector mounted upon said interior surface portion of said headrest.

20. The furniture piece as set forth in claim 17, wherein:
said pair of oppositely disposed actuators comprise hydraulic piston-cylinder assemblies.

21. The furniture piece as set forth in claim 13, wherein:
said backrest has a substantially U-shaped configuration so as to accommodate said headrest when said headrest is disposed at said retracted position.
